(19) United States
(12) Patent Application Publication
(10) Pub. No.: US 2005/0187701 A1
(43) Pub. Date: Aug. 25, 2005

(54) Traffic communication system

(76) Inventor: Douglas M. Baney, Los Altos, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/785,590

(22) Filed: Feb. 23, 2004

(51) Int. Cl. G06F 19/00

(52) U.S. Cl. 701/117; 340/907

(57) ABSTRACT

Embodiments in accordance with the invention provide communication between vehicles and traffic control devices and/or other vehicles. The communication system provides for communication of system variables such as: signal setting (e.g., red/yellow/green light), signal direction, time to signal change, signal sequence (e.g., next traffic flow), red light runner alert, signal failure, driver urgency, vehicle presence, absolute vehicle location, toll collection information, vehicle speed, roadway condition (e.g., ice on bridge surface), traffic impairments (e.g., delay ahead). The communication system also provides for communication of system variables such as: speed, acceleration/deceleration, braking, lane change with direction, malfunction (e.g., stall). The system communicates utilizing wireless optical, acoustic and/or radio frequency signaling methods.

### FIELD OF THE INVENTION

Embodiments in accordance with the invention relate to traffic control systems, and more particularly to a system for communication system variables.

### BACKGROUND OF THE INVENTION

As depicted in FIG. 1, an exemplary traffic network 100 is shown. The exemplary traffic network 100 includes one or more roadways 110 each having one or more lanes 120, one or more vehicles 130, 140, 160, 170 and one or more traffic control devices 150. Such conventional traffic networks are plagued with inefficient traffic flow, delays, and accidents. The traffic networks are characterized primarily by passive communication means (e.g., red, yellow and green lights) and/or communication means requiring manual operation (e.g., breaking) by the operators of vehicles.

For example, there is no highly effective means of alerting other drivers at an intersection of a vehicle that is not yielding to a stop sign or a red light. As a result, numerous collisions occur at intersections. Similarly, drivers regularly fail to notice that a traffic light 150 has failed, and thus it is to be treated as a stop sign. Accordingly, the inattentive driver may end-up causing a collision.

In another example, two vehicles 130, 140 may try to merge into the same lane at the same time and location (as depicted by arrows 131 and 141). One or both drivers may have difficulty in seeing that the other driver adjacent them is changing into the same lane, even if both drivers are using their blinkers. A collision can be the unfortunate consequence.

Furthermore, such communication means provide limited information. For example, a yellow light indicates that a red light is imminent. However, some yellow lights last longer than others. Hence, drivers do not know how long the light will remain yellow. As a result, some drivers assume the traffic light will remain yellow longer than it normally will. Such drivers therefore enter the intersection after the traffic light changes to red. Alternatively, a driver may have to brake excessively to stop in time. In addition, a driver may stop when there is sufficient time to pass through the intersection. Drivers who stop early may end-up being rear-ended by a driver who believes that there is sufficient time to make it through the traffic light and therefore is not expecting the other driver to break.

In another example, careless drivers regularly fail to stop at intersection in the proper position so that traffic control sensors can detect their presence. The driver may stop their vehicle beyond traffic sensor embedded in the roadway, or may straddle two sensor areas such that they do not activate the sensors. Similarly, a vehicle (e.g., motorcycle) may be too light or too small to be detected by sensors embedded in the roadway or sensors mounted on light posts.

Hence, the limitations of conventional traffic control systems result in inefficient vehicle traffic flow and inadequate traffic safety.

### SUMMARY OF THE INVENTION

Embodiments in accordance with the invention provide a traffic communication system for communicating system variables between vehicles or between one or more traffic control devices and one or more vehicles. The traffic control device is equipped with a traffic management module, an encoder and a transmitter. The traffic management module receives or determines a system variable. The encoder encodes the system variable into a signal, which is transmitted by the transmitter. A vehicle is equipped with receiver, a decoder and a visual display or audio alert unit. The receiver receives the transmitted signal. The decoder recovers the system variable from the received signal. The system variable is then output to a vehicle operator on the visual display or audio alert unit.

The communication system provides communication of system variables such as: signal setting (e.g., red/yellow/green light), signal direction, time to signal change, signal sequence (e.g., next traffic flow), red light runner alert, signal failure, driver urgency, vehicle presence, absolute vehicle location, toll collection information, vehicle speed, roadway condition (e.g., ice on bridge surface), traffic impairments (e.g., delay ahead). The communication system also provides for communication of system variables such as: speed, acceleration/deceleration, braking, lane change with direction, malfunction (e.g., stall).

System variables are communicated utilizing wireless optical means. In another embodiment in accordance with the invention, system variables are communicated utilizing a wireless hybrid of optical transmission and one or more other transmission means such as acoustic and/or radio frequency.

Embodiments in accordance with the invention are advantageous in that communication between vehicles and traffic control devices and/or inter-vehicle communication is improved. Accordingly, the traffic network communication system improves traffic efficiency and safety.

### BRIEF DESCRIPTION OF THE DRAWINGS

Embodiments in accordance with the invention are illustrated by way of example and not by way of limitation, in the figures of the accompanying drawings and in which like reference numerals refer to similar elements and in which:

FIG. 1 shows an exemplary prior art traffic network.

FIG. 2 shows a traffic communication system in one embodiment in accordance with the invention.

FIG. 3 shows a traffic communication system in one embodiment in accordance with the invention.

FIG. 4A shows a front view of an optical transmitter in one embodiment in accordance with the invention.

FIG. 4B shows a side view of an optical transmitter in one embodiment in accordance with the invention.

FIG. 5 shows a schematic diagram of optical transmitter in one embodiment in accordance with the invention.

FIG. 6 shows a method of communicating system variables of a traffic network in one embodiment in accordance with the invention.

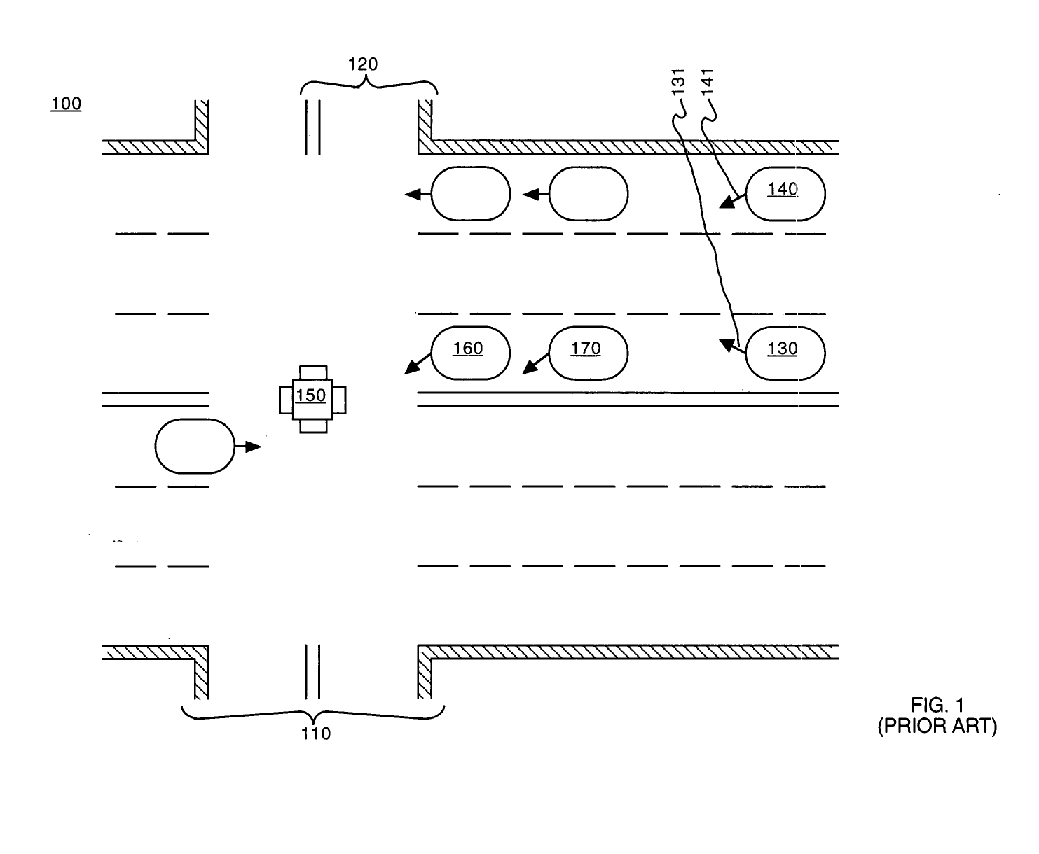

### DETAILED DESCRIPTION

Reference will now be made in detail to embodiments in accordance with the invention, examples of which are illustrated in the accompanying drawings. While various embodiments in accordance with the invention will be described, it will be understood that they are not intended to limit the invention to these embodiments in accordance with the invention. On the contrary, the invention is intended to cover alternatives, modifications and equivalents, which may be included within the spirit and scope of the invention as defined by the appended claims. Furthermore, in the following detailed description, numerous specific details are set forth in order to provide a thorough understanding of various embodiments in accordance with the invention. However, it is understood that the invention may be practiced without these specific details. In other instances, well-known methods, procedures, components, and circuits have not been described in detail as not to unnecessarily obscure aspects of embodiments in accordance with the invention.

Embodiments in accordance with the invention provide communication between vehicles and traffic control devices and/or other vehicles. The communication system provides for communication of various system variables. The system communicates utilizing wireless optical signaling methods. In addition, the system can further utilize wireless acoustic and/or radio frequency signaling methods.

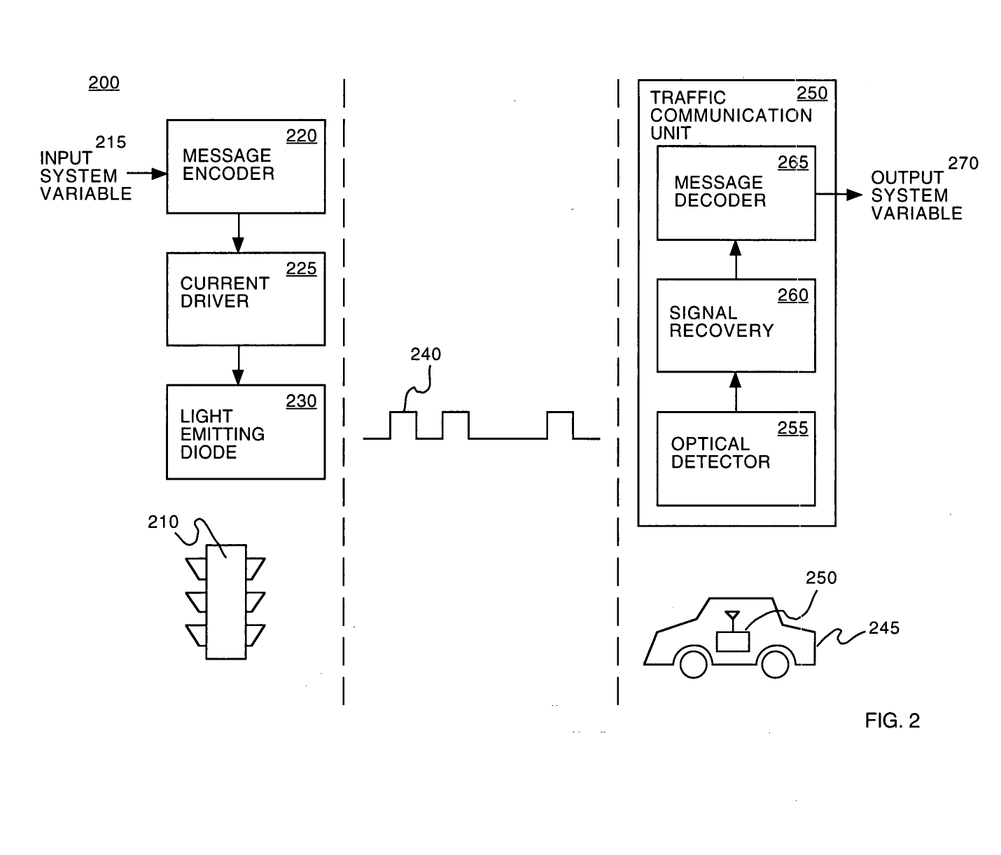

Referring now to FIG. 2, a traffic communication system 200, in one embodiment in accordance with the invention, is shown. As depicted in FIG. 2, the traffic communication system 200 includes one or more traffic control devices 210 and one or more traffic communication units 250 to be in respective vehicles 245. The traffic control devices 210 and the traffic communication units 250 communicate wirelessly employing optical signaling methods, or a hybrid of optical, acoustic and/or radio frequency signaling methods.

In one embodiment in accordance with the invention, each traffic control device 210 includes a message encoder 220, a current driver 225 and a light source 230. The message encoder 220 receives a system variable as an input 215 and generates a small signal representation thereof. In one embodiment in accordance with the invention, the encoder 220 utilizes a forward error correction coding scheme.

The message encoder 220 is communicatively coupled to the current driver 225. The current driver 225 provides a drive signal, which is modulated by the signal representation of the input data 215. The current driver 225 is communicatively coupled to the light source 230. The modulated drive signal results in an intensity modulated optical output 240, which is a function of the input system variable 215. The intensity modulated optical output 240 is transmitted through free space.

The light source 230 can include a light emitting diode (LED) or a vertical cavity surface emitting laser (VCSEL). In one embodiment in accordance with the invention, each light (e.g., red, green and yellow) in a traffic control device includes a plurality of LEDs. The modulated drive signal results in an intensity modulated optical output 240 from one or more of the plurality of LEDs. The LEDs are readily modulated at low and medium data rates (e.g., below 100 MHz). In another embodiment, each light in the traffic control device includes a plurality of LEDs providing an un-modulated optical output (e.g., normal signal state) and one or more VCSELs providing a modulated optical signal for communicating data. In another embodiment, each light in the traffic control device includes a plurality of VCSEL providing the un-modulated (e.g., normal signal state) and the modulated optical signal for communicating data. The VCSELs are readily modulated at medium to high data rates (e.g., above 100 MHz). The VCSELs also have increased optical efficiency (e.g., output intensity relative to drive power consumed), as compared to LEDs.

In one embodiment in accordance with the invention, the input system variable is modulated onto a synchronized pulse stream, where the information is represented by the presence or absence of pulses. The modulation rate is sufficiently high that the traffic signal (e.g., red light) appears constant to vehicle operators. In one implementation, the modulation utilizes a fifty percent duty cycle pulse width. In another embodiment in accordance with the invention, the traffic control device 210 provides pulse code dimming. Pulse code dimming decreases the on-state pulse width during low light conditions, when less intensity is required (e.g., nighttime), and/or increases the on-state pulse width during bright light conditions (e.g., daytime).

In one embodiment in accordance with the invention, the information may be transmitted during each state of the traffic control device (e.g., red, green and yellow). In another embodiment in accordance with the invention, one or more states are reserved for transmitting one or more categories of information (e.g., emergency response vehicle traffic signal control).

In one embodiment in accordance with the invention, each vehicle 245 includes a traffic communication unit 250. Each traffic communication unit 250 includes an optical detector 255, a signal recovery circuit 260, and message decoder 265. The optical detector 255 receives the optical output 240 from the light source 230 of the traffic control device 210. The optical detector 255 convert the intensity modulated optical output 240 into an electrical signal. In one embodiment in accordance with the invention, the optical detector 255 includes a photo diode and amplifier. The photo diode can be an avalanche photo-diode (APD) or a PIN (p-region/intrinsic-region/n-region) diode.

The output of the optical detector 255 is communicatively coupled to the signal recovery circuit 260. The signal recovery circuit 260 isolates the modulated signal component from a noise component. The signal recovery circuit 260 is communicatively coupled to the signal decoder 265. The signal decoder 265 decodes the system variable from the modulated electrical signal. The system variable can then be output 270 to a vehicle operator and/or a control component of the vehicle 245 (e.g., collision avoidance system).

Although the above-described embodiments of the invention illustrate simplex communication, it is appreciated that the communication system 200 can include duplex communication. In such embodiments in accordance with the invention, the traffic control device 210 further includes an optical detector, a signal recovery circuit and a message decoder. The traffic communication unit 250 of each vehicle 245 further includes a message encoder, current driver and light source. Such embodiments of the communication system, providing duplex communication, are described in more detail below.

It is also appreciated that the communication system 200 can provide for communication between vehicles 245. In such embodiments in accordance with the invention, each traffic communication unit 250 of each vehicle 245 includes a message decoder 265, a signal recovery circuit 260, a optical detector 255, a light source, a current driver and a message encoder. Inter-vehicle communication is provided by means similar to the above-described communication between the traffic control device 210 and the traffic communication unit 250 of each vehicle 245. Such embodiments of the communication system, providing inter-vehicle communication, are also described in more detail below.

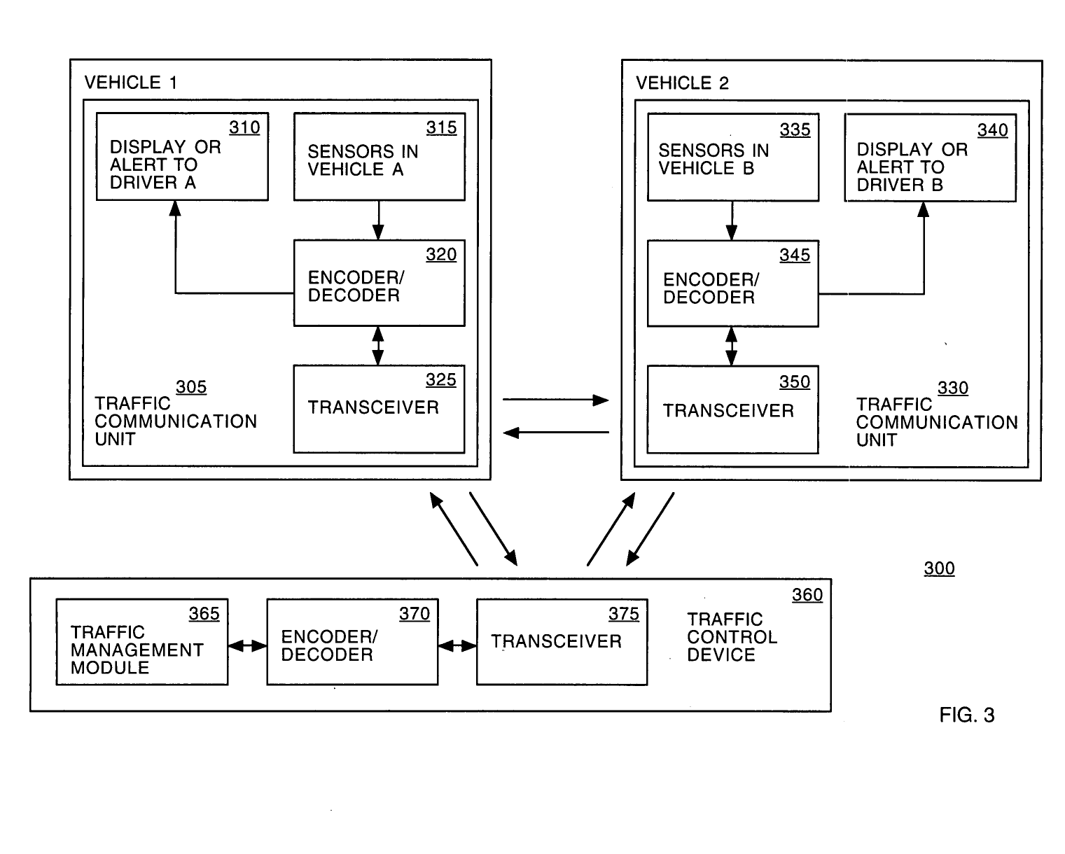

Referring now to FIG. 3, a traffic communication system 300, in one embodiment in accordance with the invention, is shown. As depicted in FIG. 3, the traffic communication system 300 provides for wireless communication between two or more vehicles 1 and 2 and/or between one or more vehicles 1 and 2 and one or more traffic control devices 360. The traffic communication system 300 transmits and receives information about a traffic network. The information includes system variables such as signal setting (e.g., red/yellow/green light), signal direction, time to signal change, signal sequence (e.g., next traffic flow), red light runner alert, signal failure, driver urgency, vehicle presence, absolute vehicle location, toll collection information, speed limit, roadway condition (e.g., ice on bridge surface), traffic impairments (e.g., delay ahead), vehicle speed, acceleration/deceleration, braking, lane change with direction, malfunction (e.g., stall), and/or the like. Each vehicle 1, 2 and/or traffic control device 360 communicates with one or more other vehicles 1,2 and/or traffic control devices 360 utilizing a protocol. The protocol may establish a communication channel and/or control the flow of information. In one embodiment in accordance with the invention, the communication protocol is based upon the same principles linking personal computers and/or servers to in a local area network.

In one embodiment in accordance with the invention, a traffic communication unit 305 of vehicle 1 includes a transceiver 325, an encoder/decoder 320, one or more sensors 315, and one or more visual display or audio alert units 310. The sensor 315 provides one or more system variables to the encoder/decoder 320. The encoder/decoder 320 encodes the system variable into a signal that the transceiver 325 transmits through free space.

The traffic communication unit 330 of vehicle 2 includes a transceiver 350, an encoder/decoder 345, one or more sensors 335, and one or more visual display or audio alert units 335. The transmitted signal is received by the transceiver 350 and is converted into a received signal. The encoder/decoder 345 decodes the received signal to recover the data encoded therein. The data is then presented to the operator of the second vehicle on a visual display unit and/or an audio alert unit 340, and/or utilized by a control component of vehicle 2 (e.g., collision avoidance system).

For example, when two vehicles (e.g., 130, 140) are trying to enter the same lane at the same location, the system 300 provides a means of alerting one or both of the vehicle operators that the other vehicle is entering the lane. The traffic communication unit 305 of vehicle 1 transmits a system variable such, as lane change, direction and absolute location, to vehicle 2. The traffic communication unit 330 of vehicle 2 receives the system variable and presents it to the operator of vehicle 2. Similarly, the traffic communication unit 330 of vehicle 2 can also transmit its corresponding lane change, direction and absolute location information to vehicle 1. The traffic communication unit 305 of vehicle 1 receives and presents the information to the operator of vehicle 2. Thus, the system 300 can reduce the likelihood that the two vehicles will collide due to merging into the same lane at the same time and place.

In another example, the system 300 provides a means for the traffic communication unit 305 of vehicle 1 to alert the operator and/or control component of vehicle 2 that vehicle 1 is braking. The traffic communication unit 330 of vehicle 2 receives the system variable that vehicle 1 is braking and presents it to the operator of vehicle 1. Thus, the system 300 can reduce the likelihood that the operator of vehicle 2 will rear-end vehicle 1.

In another example, the system 300 provides a means for measuring the speed of a vehicle 1, 2. The transceiver 375 of the traffic control device 360 can measure velocity of a vehicle utilizing swept wavelength or pulse width modulation technique as well-known in the art of radar and lidar. Accordingly, the traffic control device 360 may broadcast warning information to other vehicles and/or law enforcement.

In yet another example, the system 300 provides a means for the traffic communication unit 305 of vehicle 1 to alert other vehicles that it is disabled. The traffic communication unit 305 of vehicle 1 broadcasts a system variable indicating that vehicle 1 is disabled (e.g., stalled). The traffic communication units of the other vehicles receive the system variable and present it to the operator of the given vehicle. Thus, the system 300 can reduce the likelihood that a collision with vehicle 1 occurs. Furthermore, the operators of the other vehicles can take alternative routes to avoid any associated delay caused by disabled vehicle 1.

In one embodiment in accordance with the invention, a traffic control device 360 includes a transceiver 375, an encoder/decoder 370, a traffic management module 365. The traffic management module 365 provides data to the encoder/decoder 370. The encoder/decoder 370 encodes the data into a signal that the transceiver 375 transmits through free space.

The traffic communication unit 305 of vehicle 1 includes a transceiver 325, an encoder/decoder 320, one or more sensors 315, and one or more visual display or audio alert units 310. The transmitted signal is received by the transceiver 325 and converted into a received signal. The encoder/decoder 320 decodes the received signal to recover the system variable. The system variable is then presented to the operator of vehicle 1 on a visual display unit and/or an audio alert unit 310.

For example, vehicle presence (e.g., five cars waiting to make a left turn) information is utilized by the system 300 to gate the flow of traffic (e.g., change signal setting). The traffic communication units of one or more vehicles transmit data indicating their presence to the traffic control device 360, such as a traffic light with a protected left-turn signal state (e.g., 160, 170). Upon receipt and decoding of the transmitted system variable, the traffic management module 365 of the traffic control device 360 can change the state of the traffic signal to respond to the presence of the one or more vehicles desiring a particular signal state. Accordingly, the system 300 improves the gating of traffic.

In another example, the system 300 transmits the current state and the signal direction of the traffic control device 360, such as a traffic light, to the traffic communication units of one or more vehicles. The received signal is decoded to determine the current state of the traffic control device 360 applicable to the direction in which each vehicle is traveling. The current state of the traffic control device (e.g., red, green or yellow light) is then presented to the operator of each of the one or more vehicles utilizing a respective audio alert or visual display unit. The audio alert is useful for vehicle operators that have a limitation, such as color blindness.

In another example, the system 300 may communicate information about the traffic control sequence to the traffic communication unit of one or more vehicles. The information can be a count indicating when the current traffic signal state will expire. Such information can be received and decoded by the traffic communication units 305, 330 of the one or more vehicles and presented to the respective operators. Thus, in addition to knowing that the traffic light is currently yellow an operator can also receive a count indicating how long the light will remain yellow. Such information can assist a vehicle operator in determining if they can proceed under the yellow or if they should prepare to stop.

In yet another example, when a traffic light fails, the system 300 provides a back-up means for alerting operators of vehicles that the device 360 has failed. The system 300 can include logic in the traffic control module 365 to detect that the system has failed and transmit appropriate system variable utilizing one or more optical, acoustic and/or radio frequency transmission means. The traffic communication units 305, 330 of one or more vehicles approaching the failed traffic light receive the signal and decode the data contained therein. Accordingly, the operator of each vehicle 305, 330 is alerted that the traffic light has failed. In addition, each operator can also be advised that the failed traffic light is to be treated as a four-way stop. Thus, the system 300 reduces the likelihood that two or more vehicles collide due to the failure of the traffic light.

In one embodiment in accordance with the invention, the input data is encoded as a synchronized pulse stream, where the information is represented by the presence or absence of pulses. The encoder can utilize a forward error correction coding scheme when encoding the data as a synchronized pulse stream. The forward error correction code enables the decoder to detect and correct transmission errors.

In one embodiment in accordance with the invention, the transceiver 325, 350, 375 includes an optical transmitter. The optical transmitter can include a light emitting diode (LED) or a vertical cavity surface emitting laser (VCSEL). In one embodiment in accordance with the invention, the optical transmitter includes one or more LEDs. The LEDs transmit an intensity modulated optical signal. The LEDs are readily modulated at low and medium data rates (e.g., below 100 MHz). In another embodiment, the optical transmitter includes one or more VCSELs. The VCSELs transmit an intensity modulated synchronized pulse stream. The VCSELs are readily modulated at medium to high data rates (e.g., above 100 MHz). The VCSELs also exhibit increased efficiency (e.g., optical output intensity relative to drive power consumed), as compared to LEDs.

In one embodiment in accordance with the invention, the optical transmitter 325, 350, 375 provides for pulse code dimming. Pulse code dimming decreases the on-state pulse width during low light conditions, when less intensity is required (e.g., nighttime), and/or increases the on-state pulse width during bright light conditions (e.g., daytime).

In one embodiment in accordance with the invention, the transceiver 325, 350, 375 includes an optical receiver. The optical receiver can include an avalanche photo-diode (APD) or a PIN (p-region/intrinsic/n-region) diode.

In one embodiment in accordance with the invention, the transceiver 325, 350, 375 includes an optical transmitter, one or more other types of transmitters, such as an acoustic or radio frequency transmitter, and one or more receivers, such as an optical, acoustic or radio frequency receiver. In another embodiment in accordance with the invention, the transceiver 325, 350, 375 includes one or more types of transmitters, such as an optical, acoustic or radio frequency transmitter, an optical receiver, and one or more other types of receiver such as an acoustic or radio frequency receiver.

In one embodiment in accordance with the invention, the transceiver 325, 350, 375 is located on the vehicles and traffic control devices 360 to provide a clear transmission path. The transceiver 325 on a vehicle can be located on the roof, windshield, hood, bumper, hubcap, trunk, in a headlight, a taillight, proximate the rearview mirror or side view mirror, in a marker light or the like. In another embodiment in accordance with the invention, each vehicle is equipped with two or more transceivers 325 located on different areas of the vehicle to provide redundancy and/or to provide a clear transmission path in different directions.

In one embodiment in accordance with the invention, system variables can be transmitted during each state of a traffic control device 360 (e.g., red, green and yellow). In another embodiment, one or more states are reserved for transmitting one or more categories of system variables (e.g., emergency response vehicle traffic signal control).

In one embodiment in accordance with the invention, information can run back through traffic to other vehicles that are not in communication with the particular traffic control device 360 or vehicle. The information is re-transmitted by a given vehicle to other vehicle behind it and so on such that vehicles that are outside the transmission range of the traffic control device 360 or a particular vehicle 305 receive such information in advance of entering the transmission range.

In one embodiment, the traffic control device 360 is one or more devices, or is associated with one or more devices, selected from the group of devices including but not limited to: stop lights, speed limit signs, traffic advisory message boards, traffic advisory radio stations, street lights, toll gates, roadside emergency phones, stop signs, yield signs, route markers, exit signs, and traffic cameras.

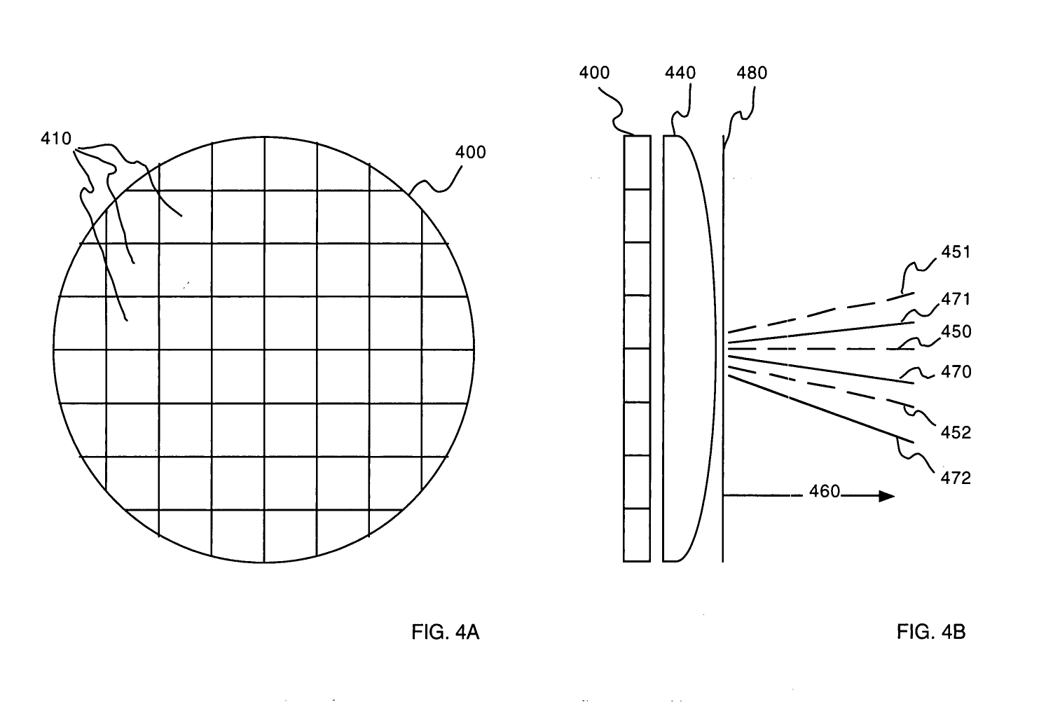

Referring now to FIG. 4A, a front view of an optical transmitter 400, in one embodiment in accordance with the invention, is shown. As depicted in FIG. 4A, the optical transmitter 400 includes a plurality of LEDs, a plurality of LEDs and one or more VCSEL, or a plurality of VCSELs 410. The optical transmitter 400 can be utilized as a dedicated transmitter. The optical transmitter can also be utilized as a transmitter and a normal traffic control indicator, such as a red, green and/or yellow lamp of a traffic light.

Referring now to FIG. 4B, a side view of an optical transmitter 400, in one embodiment in accordance with the invention, is shown. As depicted in FIG. 4B, a lens 440 is utilized to steer the output of the optical transmitter. Without a lens 440 the output has a first radiation pattern 450, 451, 452. As the output radiates, it diverges 451, 452 as a function of the distance 460 from the optical transmitter 400. Thus, the power level of the radiation pattern of the optical transmitter diminishes the further it travels. The further away the vehicle is the more the optical signal diverges, which results in a decrease in optical signal intensity.

The lens 440 is utilized to steer 470, 471, 472 the radiation pattern of the optical signal. The high intensity portion 470 of the radiation pattern is aimed at more distant vehicles. The distant vehicles therefore receive the signal with sufficient power level for effective detection, despite divergence of the optical signal due to the long path distance. In addition, relatively close vehicles, although in the less intense portion 472 of the radiation pattern, are sufficiently close such that the received signal has a sufficient power level for detection. Accordingly, the lens 440 allows the optical signal to be readily received by both near and distant vehicles.

Although FIG. 4B illustrates a single lens 440 for the entire optical transmitter 440, it is appreciated that each individual light source 410 may have a lens associated therewith for steering the individual output of each light source 410. In addition, steering may be achieved by a convex lens positioned slightly off center of the axis of the un-steered radiation pattern. Steering may also be achieved by utilizing a micro actuator (e.g., microelectromechanical system) to reflect the light in a desired direction.

As depicted in FIG. 4B, a diffraction grating 480 is utilized to diffuse the output of the optical transmitter. In VCSEL or laser transmitters, the eye safe limit of the optical output becomes an issue. The coherent light emitted from a small aperture, such as a VCSEL, causes the human eye to focus the light very narrowly thereby causing eye damage (e.g., burning). For example at a wavelength of 800 nm, the eye safe limit is about 780 μW. LEDS on the other hand have much larger aperture areas and therefore allow for high power transmission levels without causing eye damage. Therefore, a diffraction grating 480 alone or in combination with a lens 440 can be utilized to diffuse the optical signal. Diffusion results in a reduction in spatial coherency of the optical signal. The scattering increases the effective area of the light source, thus increasing the eye safe power level of operation.

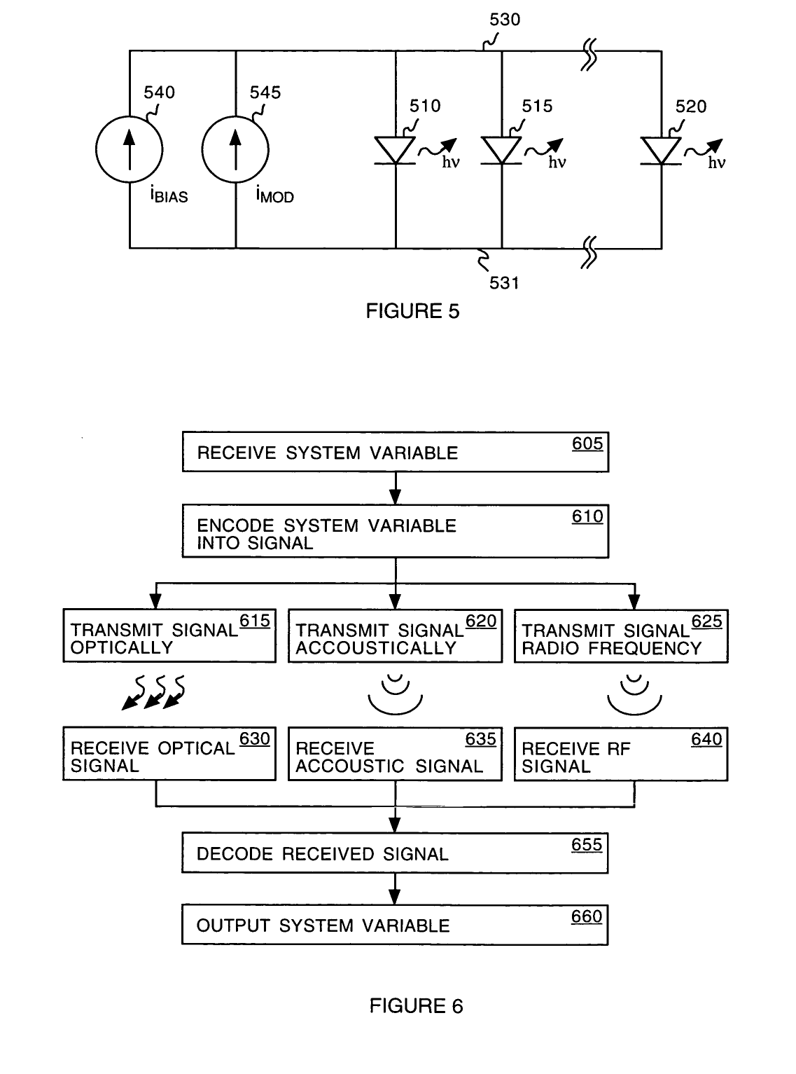

Referring now to FIG. 5, a schematic diagram of optical transmitter, in one embodiment in accordance with the invention, is shown. As depicted in FIG. 5, the optical transmitter includes a plurality of optical sources 510, 515, 520 connected to a bus 530, 531. A constant current source, i_{BIAS}, provides a drive current. A time varying current source, i_{MOD}, provides a modulated drive current. Although not shown, it is appreciated that a regulator is coupled to each optical source 510, 515, 520 to control the exact current level to each optical source 510, 515, 520, because each device typically operates at a slightly different current level from each other. Accordingly, the optical output is an intensity modulated signal, hv.

Referring now to FIG. 6, a method of communicating system variables of a traffic network, in one embodiment in accordance with the invention, is shown. As depicted in FIG. 6, the method includes receiving a system variable, at 605. In one embodiment in accordance with the invention, the system variable is received by a communication system component (e.g., traffic communication unit) of a vehicle or a traffic control device. The system variable can be, but is not limited to, information such as signal setting (e.g., red/yellow/green light), signal direction, time to signal change, signal sequence (e.g., next traffic flow), red light runner alert, signal failure, driver urgency, vehicle presence, absolute vehicle location, toll collection information, speed limit, roadway condition (e.g., ice on bridge surface), traffic impairments (e.g., delay ahead), vehicle speed, acceleration/deceleration, braking, lane change with direction, and/or malfunction (e.g., stall).

At 610, the system variable is encoded into a signal. In one embodiment in accordance with the invention, the signal includes a bias current and a modulation current. In one embodiment in accordance with the invention, the signal is a synchronized pulse stream, where the system variable is represented by a particular combination of the presence or absence of pulses.

At 615, the signal is optically transmitted into free space. Furthermore, embodiments of the invention, transmit the signal as an acoustic signal, at 620, and/or as a radio frequency signal, at 625, as an alternative method of transmission or in addition to the optical method of transmission.

At 630, the optical signal propagating in free space is received. Optionally, embodiments of the invention provide for receiving the acoustic 635 and/or radio frequency signal 640.

At 655, the received signal is decoded to determine the system variable. The system variable is then output, at 660. In one embodiment in accordance with the invention, the system variable is output by a communication system component of a vehicle and/or a traffic control device.

For example, a traffic communication unit of a vehicle receives the speed, acceleration, absolute vehicle location and/or braking system variable from a sensor of the vehicle, at 605. The speed, acceleration, absolute vehicle location and/or braking information is encoded on a synchronized pulse stream, at 610. The synchronized pulse stream representation of the speed, acceleration, absolute vehicle location and/or braking information is transmitted as an optical signal by a VCSEL located in the vehicle's headlight to a traffic signal.

The communication system component of the traffic signal receives the optical signal transmitted by the vehicle, at 630. The received optical signal is decoded to recover the speed, acceleration, absolute vehicle location and/or braking information of the vehicle, at 655. The speed, acceleration, absolute vehicle location and or braking system variable of the vehicle is then output to the traffic management module of the traffic signal, at 660. The traffic management module utilizes the speed, acceleration, absolute vehicle location and/or braking information of the vehicle and the current state of the traffic signal applicable to the vehicle, to detect if the vehicle is running or about to run a red light.

If the traffic light determines that the vehicle is running or is about to run the red light, a red light runner alert can be generated. The red light runner system variable is received by the communication system component of the traffic signal, at 605. The red light runner information is encoded on a synchronized pulse stream, at 610. The synchronized pulse stream representation of the red light runner information is transmitted as an optical signal by a VCSEL located in the traffic signal to other vehicles, at 615.

The traffic communication unit of the other vehicles receive the optical signal transmitted by the traffic light, at 630. The received optical signal is decoded to recover the red light runner alert system variable, at 655. The red light runner alert is then output to an audio and/or visual display unit of the other vehicles, at 660 or utilized by a control component (e.g., collision avoidance system). Thus, the operators of the other vehicles may receive sufficient warning of the vehicle running the red light, such that they can take evasive action to avoid or minimize a collision with the vehicle running the red light.

In another example, a traffic communication unit of an emergency vehicle, such as an ambulance, receives one or more system variables, at 605. The system variables are encoded, at 610. The encoded signal is transmitted as an optical, acoustic and/or radio frequency signal by the ambulance, at 615, 620, 630.

The signal transmitted by the traffic communication unit of the ambulance is received by the traffic communication units of one or more vehicles and/or one or more traffic control devices, at 630, 635, 640. The received signal is decoded at 655 to recover the one or more system variable, at 655. The system variables are output on an audio or visual display of each vehicle. Thus, the operators of the vehicles can be alerted to the approaching emergency vehicle. Similarly, the system variables are received by the traffic management module of each traffic signal. Thus, the traffic management module of each traffic signal can change the current state of the signal to stop cross traffic, and allow vehicle to pass that are in the direction of travel of the emergency vehicle, such that the vehicles do not block the emergency vehicle from readily proceeding safely through the intersection.

Embodiments in accordance with the invention are advantageous in that improved communication between vehicles and traffic control device and/or inter-vehicle communication is provided. Accordingly, the traffic network communication system improves traffic efficiency and safety.

The foregoing descriptions of specific embodiments in accordance with the invention have been presented for purposes of illustration and description. They are not intended to be exhaustive or to limit the invention to the precise forms disclosed, and many modifications and variations are possible in light of the above teaching. The embodiments in accordance with the invention were chosen and described in order to best explain the principles of the invention and its practical application, to thereby enable others skilled in the art to best utilize the invention and various modifications as are suited to the particular use contemplated. It is intended that the scope of the invention be defined by the claims appended hereto and their equivalents.

1. A traffic communication system wherein a traffic control device comprises:
a first traffic management module, for determining a first system variable;
a first encoder communicatively coupled to said first traffic management module, for encoding said first system variable as a first signal according to a protocol; and
a first transmitter communicatively coupled to said first encoder, for optically transmitting said first signal.

2. The traffic communication system according to claim 1, wherein said first system variable is selected from the group consisting of signal setting, signal direction, time to signal change, signal sequence, red light runner alert, signal failure, driver urgency, vehicle presence, absolute vehicle location, toll collection information, speed limit, roadway conditions, traffic impairments, vehicle speed, acceleration/deceleration, braking, lane change with direction and malfunction.

3. The traffic communication system according to claim 1, wherein said first transmitter further transmits said signal as one or more selected from the group consisting of an acoustic signal and a radio frequency signal.

4. The traffic communication system according to claim 1, wherein said first transmitter comprises a light emitting diode or a vertical cavity surface emitting laser.

5. The traffic communication system according to claim 1, wherein said first transmitter further comprises a lens, for steering an optical output.

6. The traffic communication system according to claim 1, wherein said first transmitter further comprises a diffraction grating, for diffusing an optical output.

7. The traffic communication system according to claim 1, wherein said traffic control device consist of one or more devices selected from the group consisting of stop light, a speed limit sign, a traffic advisory message board, a traffic advisory radio station, a street light, a toll gate, a roadside emergency telephone, a stop sign, a yield sign, a route marker, an exit sign, and a traffic camera.

8. The traffic communication system according to claim 1, wherein a first traffic communication unit, configured to be coupled to a first vehicle, comprises;
a first receiver, for receiving said first signal;
a first decoder communicatively coupled to said first receiver, for decoding said first signal to recover said first system variable; and
a first visual display or a first audio alert unit communicatively coupled to said first decoder, for outputting said first system variable.

9. The traffic communication system according to claim 8, wherein said first receiver is located on said first vehicle at one or more areas selected from the group consisting of a roof, a windshield, a hood, a headlight, a taillight, a bumper, a trunk, a hubcap, a rearview mirror, a side view mirror and a marker light.

10. A traffic communication system wherein a first traffic communication unit, configured to be coupled to a first vehicle, comprises:
a first sensor, for receiving a first system variable;
a first encoder/decoder communicatively coupled to said first sensor, for encoding said first system variable as a signal; and
a first transceiver communicatively coupled to said first encoder/decoder, for transmitting said first signal.

11. The traffic communication system according to claim 10, wherein said first transceiver comprises one or more of the group consisting of an optical transmitter, an acoustic transmitter, a radio frequency transmitter, an optical receiver, an acoustic receiver, and a radio frequency receiver.

12. The traffic communication system according to claim 10, wherein a traffic control device comprises;
a third transceiver, for receiving said first signal;
a third encoder/decoder communicatively coupled to said third transceiver, for decoding said first signal to recover said first system variable; and
a traffic management module communicatively coupled to said third encoder/decoder, for receiving said first system variable.

13. The traffic communication system according to claim 10, wherein a second traffic communication unit, configured to be coupled to a second vehicle, comprises:
a second transceiver, for receiving said first signal;
a second encoder/decoder communicatively coupled to said second transceiver, for decoding said first signal to recover said first system variable; and
a first visual display or a first audio alert unit communicatively coupled to said second encoder/decoder, for outputting said first system variable.

14. The traffic communication system according to claim 13, wherein said second transducer of said second traffic communication unit transmits said first signal to another traffic communication unit coupled to another vehicle outside the transmission range of said first vehicle.

15. A method of communicating a traffic network system variable comprising:
receiving a system variable, by a first traffic communication unit;
encoding said system variable into a signal, by said first traffic communication unit; and
transmitting said signal, by said first traffic communication unit.

16. The method according to claim 15, wherein said signal is transmitted utilizing an optical, acoustic or radio frequency means.

17. The method according to claim 15, wherein said encoding said system variable into said signal comprises modulating a synchronized pulse stream according to a communication protocol.

18. The method according to claim 15, wherein said system variable is selected from a group consisting of signal setting, signal direction, time to signal change, signal sequence, red light runner alert, signal failure, driver urgency, vehicle presence, absolute vehicle location, toll collection information, speed limit, roadway conditions, traffic impairments, vehicle speed, acceleration/deceleration, braking, lane change with direction and malfunction.

19. A method of communicating a traffic network system variable comprising:
generating a system variable, by a traffic control device;
encoding said system variable into a signal, by said traffic control device; and
transmitting said signal, by said traffic control device.

20. The method according to claim 19, wherein said encoding said system variable into said signal comprises applying pulse code dimming wherein a duty cycle of said signal is varied as a function of a light condition.
